(19) United States
(12) Patent Application Publication
(10) Pub. No.: US 2011/0291061 A1
(43) Pub. Date: Dec. 1, 2011

(54) High Tonnage Winch Systems and Methods

(76) Inventors: Agustin Costas, Ballajura (AU); Saul Wende, Floreat (AU); Daniel Forster, Warwick (AU); David Cree, Mindarie (AU)

(21) Appl. No.: 13/069,829

(22) Filed: Mar. 23, 2011

(30) Foreign Application Priority Data
May 29, 2010 (AU) 2010202208

(51) Int. Cl. B66D 1/28; B23P 17/00; B23P 11/00

(52) U.S. Cl. 254/332; 29/428; 29/426.1

(57) ABSTRACT

In one preferred form of the present invention, shown in FIG. 1, there is provided a high tonnage winch system (10) for use in offshore construction, transport and docking operations. The winch system (10) includes a winch (14) and a first arrangement (12) supporting the winch (14). A second arrangement (18) is provided for being mounted to a foundation structure in the form of a deck (20). The first arrangement (12) advantageously comprises a first low profile arrangement (16). The second arrangement (18) advantageously comprises a second low profile arrangement (24). The winch system (10) advantageously includes a low profile roller element bearing (26) connecting the first and second arrangements (12), (18) and allowing rotation of the winch (14) about the second arrangement (12), when the winch (14) is connected to the first arrangement (12) and the second arrangement (18) is mounted to the deck (20). The second arrangement is mounted to the deck (20) using high tonnage winch grillage (22).

### FIELD OF THE INVENTION

The present invention relates to high tonnage winch systems and methods. In one preferred form, the present invention provides an improved high tonnage winch base for offshore construction, transport and docking operations. It is envisaged that the preferred winch base could also be used to support hoists for use in similar offshore operations.

### BACKGROUND TO THE INVENTION

There are several problems currently facing high tonnage winch systems used in the offshore oil and gas industry for construction, transport and docking operations. In order to perform operations of this type such systems commonly employ high tonnage winches fixed to the deck of an offshore shipping vessel, barge or platform. In these systems high tonnage winches are typically fixed to the deck using specifically designed high tonnage winch grillages forming a lattice of steel beams connected to hard points on the deck.

A prior art high tonnage winch system is shown in FIG. 1. The high tonnage winch system includes a high tonnage winch bolted to high tonnage winch grillage. The high tonnage winch grillage is, in turn, bolted to a number of hard points on a deck. As shown, the winch is directly bolted to the grillage and is aligned with the steel beams. This alignment of the winch is largely dictated by the winch and grillage having to support high tonnage loads associated with offshore construction, transport and docking operations.

One difficulty with systems of this type is that the high tonnage winch must be aligned with the high tonnage winch grillage. In order to address this problem, in offshore applications, winch bases have in the past been specifically designed for mounting the high tonnage winch at an angle to the steel beams of the winch grillage.

FIG. 2 shows a prior art high tonnage winch system in which two high tonnage winches are provided. In the high tonnage winch system of FIG. 2 each winch is mounted to a specifically designed winch base. The first winch base is designed to be aligned with the perpendicular directions of a number of I-beams provided by the high tonnage winch grillage. The second winch base is designed to be offset at an acute angle a from the I-beams of the high tonnage winch grillage. This allows for improved operational flexibility where: (i) the first winch is able to perform a first set of high tonnage construction, transport and docking operations; and (ii) the second winch is able to perform a second, different set, of high tonnage construction, transport and docking operations, where the second set of operations would not otherwise be able to be performed.

It is against this background that the present invention has been developed. It is to be recognised that any material discussed in the present specification is intended to explain the context of the invention. It is not to be taken as an admission that any material formed part of the prior art base or relevant general knowledge in any particular country or region.

### SUMMARY OF THE INVENTION

According to a first aspect of preferred embodiments herein described there is provided a high tonnage winch system for use in offshore construction, transport and docking operations comprising: a first arrangement for supporting a winch in a position proximate the first arrangement; and a second arrangement for being mounted to a foundation structure; wherein the first arrangement comprises a first low profile arrangement, the second arrangement comprises a second low profile arrangement, the high tonnage winch system including a low profile roller element bearing connecting the first and second low profile arrangements and allowing rotation of the winch about the second low profile arrangement, when the winch is connected to the first low profile arrangement and the second low profile arrangement is mounted to the foundation structure.

Preferably the high tonnage winch system further comprises a locking arrangement for locking the winch in a plurality of operational positions by locking the first low profile arrangement and the second low profile arrangement in a plurality predetermined rotational conditions where the rotational conditions are associated with spaced apart intervals of no more than 45 degrees so as to allow the winch to be locked in at least 8 operational positions for either offshore construction, transport or docking operations.

Preferably the low profile roller element bearing comprises a slew ring bearing that provides relatively smooth rotation of the first low profile arrangement relative to the second low profile arrangement and which is adapted to accommodate high tonnage loads from the winch.

Preferably the first arrangement comprises a low profile planar element having side walls no more than 35 mm high. Preferably the second arrangement comprises a low profile planar element having side walls no more than 100 mm high. Preferably the winch base with has a profile no more than 200 mm high.

Preferably the first arrangement includes lifting elements for allowing the high tonnage winch system to be readily raised and lowered during installation.

Preferably the first arrangement is provided as a single planar rectangular piece of material with the lifting members being located at each corner of the first arrangement.

According to a second aspect of preferred embodiments herein described there is provided a high tonnage winch system for use in offshore construction, transport and docking operations comprising: a winch base including a first arrangement for supporting a winch and a second arrangement for being mounted to a foundation structure; wherein the winch base includes: a roller element bearing for connecting the first and second arrangements and allowing rotation of the winch about the second arrangement, when the winch is connected to the first arrangement and the second arrangement is mounted to the foundation structure; further wherein the winch base includes a mount arrangement including a plurality of mount elements spaced apart for use in mounting the second arrangement to the foundation structure using high tonnage winch grillage of different configurations.

Preferably the high tonnage winch system includes a plurality of sacrificial elongate mounts having fastening holes for being fastened to the second arrangement using the mount elements such that the length of each sacrificial elongate mount extends along the sides of the second arrangement and presents a lower edge for being welded to the high tonnage winch grillage; wherein unfastening the sacrificial elongate plates from the mount elements allows ready separation of the winch base from the high tonnage winch grillage.

Preferably the mount elements comprise threaded holes formed so as to extend into the vertical side walls of the second arrangement when mounted to the foundation structure using the high tonnage winch grillage, the threaded holes being adapted to receive fastening bolts for holding the sacrificial elongate members to the second arrangement.

Preferably the mount elements are spaced along the vertical side walls of the second arrangement so as to allow the second arrangement to be mounted to both high tonnage winch grillage of a cruciform configuration and high tonnage winch grillage of a parallel configuration.

In preferred arrangements the mount elements are grouped into groups of mount elements along the vertical side walls of the second arrangement so as to provide different groups of the mount elements for accommodating both high tonnage winch grillage of a cruciform configuration and high tonnage winch grillage of a parallel configuration.

Preferably the second arrangement is provided as a single planar rectangular piece of material with the mount elements being grouped into three groups on each vertical side of the second arrangement.

According to a third aspect of preferred embodiments herein described there is provided a high tonnage winch system for use in offshore construction, transport and docking operations comprising: a winch; a first arrangement supporting the winch; and a second arrangement for being mounted to a foundation structure; wherein the first arrangement comprises a first low profile arrangement, the second arrangement comprises a second low profile arrangement, the system including: a low profile roller element bearing connecting the first and second arrangements and allowing rotation of the winch about the second arrangement, when the winch is connected to the first arrangement and the second arrangement is mounted to the foundation structure; and a locking arrangement for locking the winch in position by locking the first arrangement and the second arrangement in any one of a plurality predetermined rotational conditions where the rotational conditions are associated with spaced intervals of no more than 45 degrees allowing the winch to be locked in any one of at least 8 operational positions for offshore construction, transport or docking operations.

Preferably the high tonnage winch system includes a mounting arrangement for mounting the second arrangement to the foundation structure, the mounting arrangement including high tonnage winch grillage selected from the group comprising high tonnage grillage of a cruciform configuration and high tonnage grillage of a parallel configuration.

According to a fourth aspect of preferred embodiments herein described there is provided a method of installing a winch system for performing offshore construction, transport or docking operations including: attaching a high tonnage winch base to high tonnage winch grillage, the winch base comprising a first low profile arrangement that is connected to a second low profile arrangement by a low profile roller element bearing, the low profile roller element bearing allowing rotation of a winch about the second low profile arrangement; attaching the high tonnage winch base including attaching the second low profile arrangement to the high tonnage winch grillage by fastening sacrificial elongate plates having a single series of holes corresponding with mounting elements provided on the side walls of the second low profile arrangement, and welding a lower edge of each length of the sacrificial elongate plates to the high tonnage winch grillage.

According to a fifth aspect of preferred embodiments herein described there is provided method of reusing a winch system for performing offshore construction, transport or docking operations including: removing the winch base from high tonnage winch grillage attached to a foundation by firstly unfastening fasteners extending through sacrificial plates serving to hold the winch base in position, where the winch base comprises a first low profile arrangement that is connected to a second low profile arrangement by a low profile roller element bearing, the low profile roller element bearing allowing rotation of the winch about the second low profile arrangement and the sacrificial plates being attached to the second low profile arrangement; and by making use of the space provided by the removal of the winch base, removing the sacrificial mounting plates using a gas cutting torch.

As will be discussed there are considered to be a number of preferred arrangements of the present invention that provide several advantages including:
(i) The ability to re-orientate a high tonnage winch on a oil and gas service vessel or platform, where the high tonnage winch can be locked in 36 operational positions for performing a relatively large number of offshore construction, transport and docking operations.
(ii) Improved high tonnage winch systems that can be sold as a commercial off the shelf product having wide ranging usability for offshore construction, transport and docking operations as opposed to a specifically engineered high tonnage winch system having components primarily suited to only one hard point layout.
(iii) Improved high tonnage winch base systems for offshore construction, transport and docking operations where the advantageous use of a slew ring bearing between two specifically engineered winch base plates provides a relatively low profile rotatable winch base that smoothly supports a high tonnage winch and allows for a relatively large number of offshore construction, transport and docking operations on an oil and gas vessel or platform.
(iv) The ability to readily reuse a high tonnage winch base in a number of applications after the winch base has been fixed in position on high tonnage winch grillage for offshore construction, transport and docking operations.
(v) The ability to fix a high tonnage winch base to a variety of different high tonnage winch grillage layouts where the winch base can be readily installed and removed by bolting a number of sacrificial mounts along low profile side walls of a lower winch base plate.
(vi) The ability to readily mount a high tonnage winch base for offshore construction, transport and docking operations to both cruciform and parallel high tonnage winch grillage layouts, without having to engineer the mounting arrangement to the same degree as is presently the case with conventional angularly offset high tonnage winch bases for offshore applications.

It is to be recognised that other aspects, preferred forms and advantages of the present invention will be apparent from the specification including the detailed description, drawings and claims.

It is to be appreciated that the present invention may also find application in onshore applications such as on building sites and on trucks, possibly using different forms of hoist type winches. Whilst the present invention is adapted for use in offshore construction, transport and docking operations, the present invention is not limited to these applications. The applicant is presently investigating use of the advantageous winch base with trucks and general onshore construction.

### BRIEF DESCRIPTION OF DRAWINGS

In order to facilitate a better understanding of the present invention, several preferred embodiments will now be described with reference to the accompanying drawings, in which:

FIG. 1 provides two views of a prior art high tonnage winch system referred to above;

FIG. 2 provides three views of a further prior art high tonnage winch system referred to above;

FIG. 3 provides a perspective view of a high tonnage winch system according to a first preferred embodiment of the present invention;

FIG. 4 provides an exploded partial perspective view of the high tonnage winch system shown in FIG. 3;

FIG. 5 provides four partial views of the high tonnage winch system shown in FIG. 3;

FIG. 6 provides a perspective view of the high tonnage winch system shown in FIG. 3 together with a perspective view of a high tonnage winch system according to another preferred embodiment of the present invention;

FIG. 7 provides an illustrative view of a method according to yet another preferred embodiment of the present invention;

FIG. 8 provides three views illustrating a winch base used in the method shown in FIG. 7, the winch base comprising yet another preferred embodiment to the present invention;

FIG. 9 illustrates a prior art offshore application involving two conventional winches;

FIG. 10 illustrates an offshore application according to a preferred embodiment of the present invention;

FIGS. 11 and 12 provide engineering drawings of the prior art winch system shown in FIG. 2 serving to illustrate the complexity of conventional high tonnage winch base systems for offshore construction, transport and docking operations.

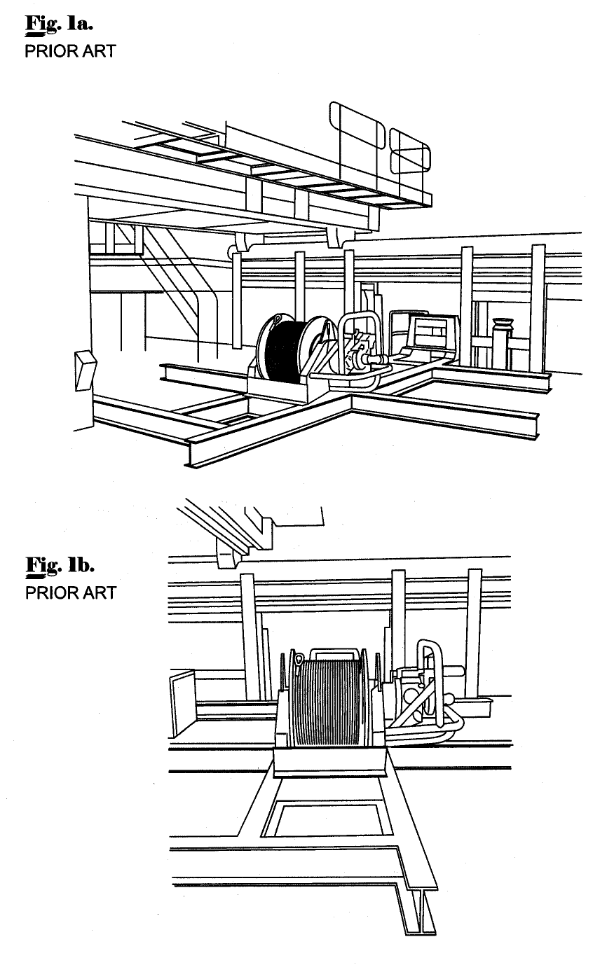

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

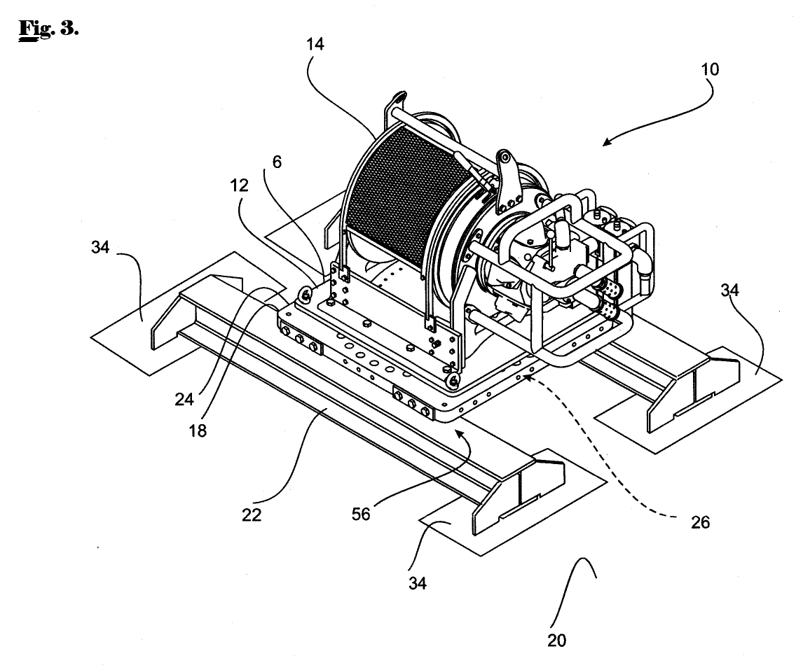

Referring to FIG. 3, there is shown a high tonnage winch system 10 for use in offshore construction, transport and docking operations. The high tonnage winch system 10 comprises a first preferred embodiment of the present invention.

The high tonnage winch system 10 includes a first arrangement 12 for supporting a high tonnage winch 14 in a position immediately above the first arrangement 12. As shown in FIG. 3, the winch 14 is firmly bolted to the first arrangement 12, in the vicinity of the first arrangement 12. The first arrangement 12 is advantageously provided as a first low profile arrangement 16 in the form of a rectangularly shaped plate of a thickness of about 25 mm. In other embodiments the winch 14 may be bolted to a conventional winch base before being bolted to the first arrangement. It is to be appreciated that in either case the winch 14 is located in the proximity of the first arrangement 12. In order to retain a particularly advantageous profile, direct bolting of the winch 14 to the first arrangement 12 is preferred.

The high tonnage winch system 10 includes a second arrangement 18 for being mounted to a foundation structure in the form of a deck 20. In this embodiment, this is achieved using high tonnage winch grillage 22 in the form of two steel I-beam support elements. The second arrangement 18 is advantageously provided as a second low profile arrangement 24 comprising a rectangularly shaped plate of a thickness of about 60 mm. In addition, the second arrangement 18 is slightly larger than the first arrangement 12 in both directions in the horizontal plane so as to accommodate a standard grillage separation. The second arrangement 18 is also thicker in the vertical plane to allow for an advantageous mounting arrangement described below. The second arrangement 18 is of a construction that is adapted to support high tonnage radial, axial and moment loads.

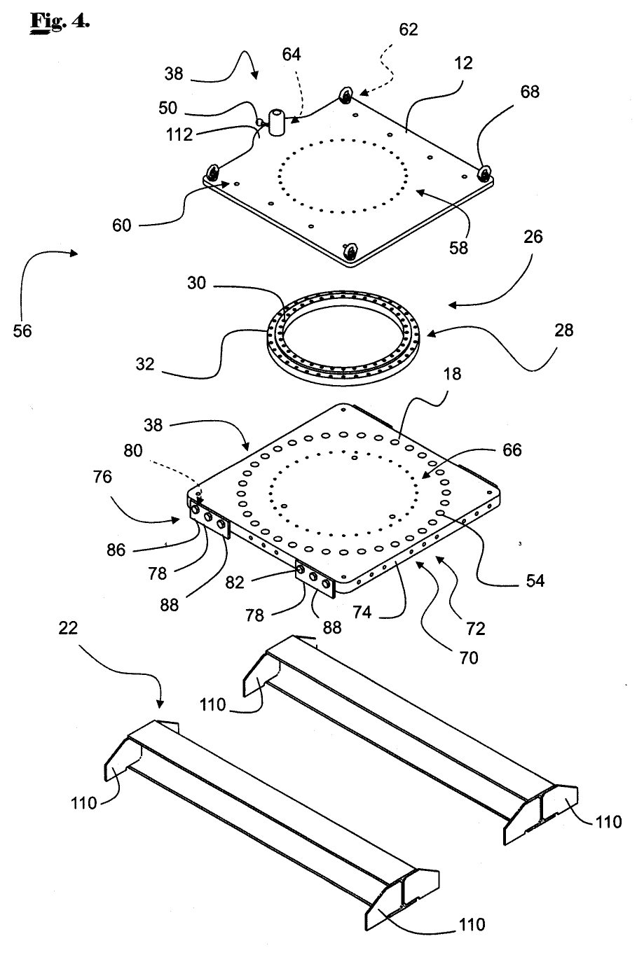

As shown in FIG. 4, the high tonnage winch system 10 includes a roller element bearing 26. The roller element bearing 26 is advantageously provided as a slew ring bearing 28 that is bolted to both the first arrangement 12 and the second arrangement 18. The slew ring bearing 28 comprises an inner race 30 connected to the first low profile arrangement 16 and an outer race 32 connected to the second low profile arrangement 24. The use of the slew ring bearing 28 advantageously provides a low profile type roller element bearing 26 that advantageously allows rotation of the high tonnage winch 14 about the second arrangement 18, when the high tonnage winch 14 is mounted to the first arrangement 12 and the second arrangement 18 is mounted to the deck 20. Advantageously the slew ring bearing 28 also serves to limit friction and provide for a smooth continuous movement supporting the weight of the system. This is particularly advantageous in offshore construction, docking and transport applications as the weight of cable in combination with the winch can be substantial.

The deck 20 includes a plurality of hard points 34. When fixed to the hard points 34, the high tonnage winch grillage 22 provides a foundation structure, upon which the second arrangement 18 is mounted. In offshore applications a hard point is point/area on a vessel deck that has sufficient structural capacity to resist the loads transferred from the winch base and grillage. Often these areas are portions of the deck plate welded directly over large integral structural elements of the vessel such as ships frames.

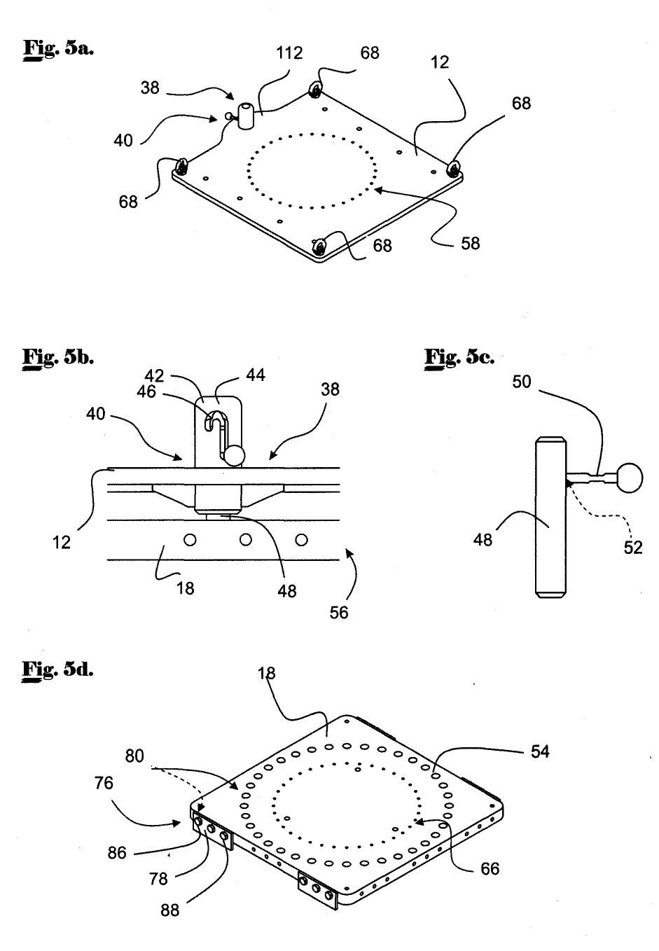

As shown in FIGS. 4 and 5, the winch system 10 includes a locking arrangement 38. The locking arrangement 38 is advantageously provided for locking the high tonnage winch 14 in 36 operational positions for offshore construction, transport and docking operations. The locking arrangement 38 is adapted to lock the first arrangement 12 and the second arrangement 18 in a plurality of predetermined rotational conditions. These rotational conditions correspond with 36 operational positions, and are associated with spaced apart intervals of 10 degrees. Advantageously the operator can be provided with 360 degrees of operational capacity. This flexibility is considered to provide significant advantages in offshore applications.

The locking arrangement 38 includes a locking pin mechanism 40 mounted to the first arrangement 12. The locking pin mechanism 40 comprises a body 42 in the form of a cylindrical barrel 44. The barrel 44 includes an inverted “J” shaped slot 46 machined into the side of the barrel 44. A retractable locking pin 48 is adapted to slide inside the barrel 44 and is further drilled and tapped at one end to accommodate a handle 50. The handle 50 includes a threaded end 52 adapted to be screwed into the locking pin 48. As such the handle 50 runs within the slot 46 and is screwed into the locking pin 48. In this particular embodiment the cylindrical barrel 44 is welded to the first arrangement 12 with the locking pin 48 being free to slide within the barrel 44.

The locking arrangement 38 further includes a plurality of locking holes 54 provided in the second arrangement 18 for receiving the locking pin 48. A non operational condition of the locking arrangement 38 corresponds with the locking pin 48 being held upwardly away from the second arrangement 18 with the handle 50 being located in the tail portion of the “J” shaped slot 46. In order to be moved towards an operative condition the handle 50 must be lifted upwardly out of the lower tail portion of the slot 46. The handle 50 must then be moved downwardly towards the second arrangement 18.

In the non-operational position the slew ring bearing 28 allows for relatively smooth rotation of the first arrangement 12 relative to the second arrangement 18 to position the high tonnage winch 14. When the high tonnage winch 14 and first arrangement 12 are in a desired position, with the locking pin 48 above one of the locking holes 54, the locking pin 48 can be moved downwardly so as to engage the corresponding locking hole. The locking arrangement 38 accordingly secures the first arrangement 12 in a desired rotational position. This is considered to provide advantageous safety, rigidity and strength for offshore construction, transport and docking operations.

Advantageously, in further embodiments, multiple locking pin mechanisms are provided to allow the winch system 10 to handle even larger loads. Multiple locking pin mechanisms also advantageously provide redundancy for particular offshore operations.

It is considered that the locking arrangement 38 provides an advantageous and effective means of preventing the first arrangement 12 from rotating relative to the second arrangement 18. The use of the slot 46 is considered to provide an intuitive mechanism for retaining the locking pin 48 in a retracted position whilst first arrangement 12 is rotated to a desired position. As such, the operator is advantageously provided with a quick visual confirmation as to whether the locking pin 48 is engaged with one of the locking holes 54. While a J-type slot is presently preferred, other advantageous slots could, of course, be provided

The 36 operational positions correspond with a circular 10 degree spacing of the locking holes 54. The ability to use the winch system 10 to position the winch in 36 operational positions is considered to provide significant operational flexibility for offshore construction, transport and docking operations. When locked in any one of these operational positions the slew ring bearing 28 is advantageously able to accommodate high tonnage axial thrust and other loads from the high tonnage winch 14. While other types of roller element bearing may possibly be able to be used, the slew ring bearing 28 is preferred and is considered to be particularly advantageous.

One advantage is that slew ring bearings are a commercially available component that does not have to be specifically manufactured for the winch system 10. This means that preferred embodiments of the present invention can be advantageously manufactured with a reduced number of component parts having to be specifically engineered and manufactured. Consequently, the overall cost of preferred arrangements is considered to be advantageously reduced.

In the case of assembly, slew ring bearings typically have a number of bolt holes provided on the outward surfaces of their inner and outer races. This means that slew ring bearings such as slew ring bearing 28 can be advantageously bolted to the first arrangement 12 and the second arrangement 18 using a number of bolts. This assists with assembly operations as the slew ring bearing 28 does not have to be welded in position. Furthermore different slew ring bearings can be selected for different loading requirements where the engineering capacity of the slew ring bearing and its performance can be determined from the manufacturer's brochure. With the capacity of the slew ring bearing 28 being the same in all radial directions this makes designing the winch system 10 a more relatively straightforward task.

In terms of maintenance, slew ring bearings incorporate specifically engineered seals to ensure long trouble free use. All that is generally required is periodic lubrication. The lubrication ensures that friction is kept to a minimum with the winch being easily able to be rotated by a single operator by hand.

In addition to all the above advantages, the use of the slew ring bearing 28 allows for the vertical profile of the winch system 10 to be kept to an advantageously small size. As would be apparent, the first arrangement 12, the second arrangement 18 and the slew ring bearing 28 advantageously provide a relatively low profile winch base 56. With the first arrangement 12 being about 25 mm high, the second arrangement 18 being about 60 mm high and the slew ring bearing being about 60 mm high, the winch base 56 can be kept to a height less than 200 mm. In this particular case the height of the winch base 56 is about 150 mm.

In addition, the winch base system 10 is scalable meaning that the features and benefits outlined equally apply to winch systems of larger or smaller capacities. In the present embodiment, the high tonnage winch 14 comprises a 5 tonne winch that uses 19 mm Gr1770 wire rope or similar. Other embodiments may support a high tonnage winch having say 2 to 5 or 5 to 10 tonne capacity. Further capacities may range up to 40 tonnes or more. In each case the components of the winch base 56 are advantageously readily engineered to provide an appropriate working load limit. Various forms of winches could of course be used including those having brakes and those particularly designed for hoisting operations.

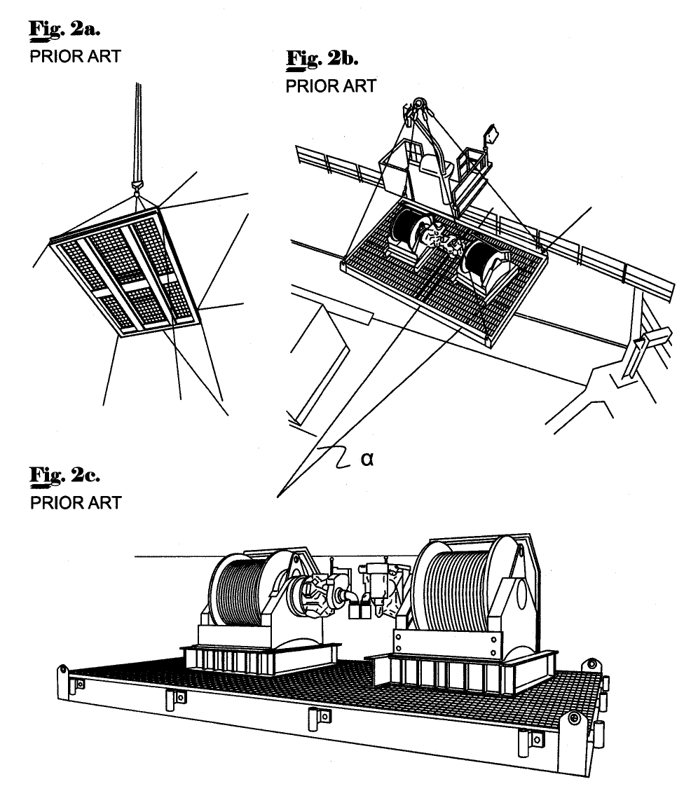

In comparison to the winch system of FIG. 2, it would be apparent that the winch system 10 can advantageously be used with a single high tonnage winch 14 to provide a relatively large number of construction, transport and docking operations on an oil and gas vessel or platform. In the case of the winch system of FIG. 2, two winches were required in a side by side configuration. The flexibility, low profile, commercial production capability and large number of operational positions provided by the winch system 10 are considered to be particularly advantageous. In fact it is envisaged that the winch system 10 could replace the need for two, three or more winches in construction, transport and docking operations on a particular offshore vessel or platform.

In the winch system 10 both the first arrangement 12 and the second arrangement 18 are provided as rectangularly shaped plates. These plates are made from steel and are able to be manufactured using a laser cut process. The simplicity of the laser cut manufacturing process is considered to outrival the manufacturing processes associated with conventional high tonnage winch bases. Of course, other means of computer numerical control profile cutting could also be implemented, including plasma, water jet or oxy acetylene cutting. In each case the manufacturing is considered to be much simpler compared to the manufacture of conventional winch bases.

As illustrated, the use of plates provides significant flexibility in that each plate can be cut and pre-drilled to accommodate the bolt pattern of the slew bearing 28 and a number of different winch types. In the present embodiment, the first arrangement 12 includes a number of slew ring bearing mounting holes 58 winch mounting holes 60, lug attachment holes 62 and a hole 64 for fixing the locking pin mechanism 40.

The second element 18 includes corresponding slew ring mounting holes 66 and the locking holes 54. Each of the slew ring mounting holes 58 and the sling ring mounting holes 66 is arranged in a circular arrangement about a rotational axis and is predrilled before the winch system 10 is assembled.

The lug attachment holes 62 in the first arrangement 12 advantageously accommodate a number of lifting elements 68 in the form of 4 off standard lift eye bolts fastened through the lug attachment holes 62. The lifting elements 68 are provided at each corner of the first arrangement 12 where the winch base 56 can be lifted using a 4-leg sling.

The winch 14 is bolted to the first arrangement 12 using the winch mounting holes 60. Other methods of fixing are of course possible. For example the mounting holes 60 may be provided in a standard configuration with a further winch base element being placed between the first arrangement 12 and the winch 14 to allow for several types of winch to be fixed to the same winch base 56. This is however presently not preferred as the profile of the overall winch system will increase. Further mounting holes 60 could be drilled if required.

It is to be appreciated that the manner of fixing the second arrangement 18 to the high tonnage winch grillage 22 is considered to be particularly advantageous. As shown in FIG. 4, the second arrangement 18 includes a number of mount elements 70 in the form of holes 72 advantageously drilled in the vertical side walls 74 of the second arrangement 18.

The holes 72 are threaded and spaced apart along the side walls 74 of the second arrangement 18 for advantageously mounting the second arrangement 18 to the deck 20 using the high tonnage winch grillage 22. In this embodiment the holes 72 form part of a mount arrangement 76 of the winch system 10.

The mount arrangement 76 advantageously includes a plurality of sacrificial elongate mounts 78 having fastening holes 80 for being fastened to the second arrangement 18 using the holes 72 and a number of corresponding fasteners 82. The sacrificial elongate mounts 78 are advantageously provided as flat sacrificial elongate plates 86 which when fixed to the second arrangement 18 extend along the sides 74 of the second arrangement 18 and present a lower edge 88 for being welded to the high tonnage winch grillage 22. The flush and narrow configuration arrangement of the sacrificial elongate plates 86, when mounted to the sides 74, provides a particularly effective and advantageous manner of attachment. Given that the second arrangement 18 is slightly larger than the first arrangement 12, in the horizontal plane, access to the sacrificial plates 86 is readily provided.

The mount arrangement 76 to the deck 20 provides a number of particularly useful further advantages. Firstly by unfastening the fasteners 82 from the holes 72, this allows ready separation of the winch base 56 from the high tonnage winch grillage 22. This advantageously allows the winch base 56 to be removed without being damaged. Furthermore the reusability in combination with the flexibility of the winch base 56 is particularly advantageous because the winch base 56 can readily used in another system where a conventional winch base such the angularly offset base shown in FIG. 2 would most likely not be suitable. Unlike conventional high tonnage winch bases the winch base 56 provides a reusable off the shelf item rather than a consumable.

Secondly, should the sacrificial elongate plates 86 be overly wide in a vertical direction, they can be readily cut with an angle grinder or otherwise to provide a fresh lower edge that when mounted will be flush with the bottom surface of the second arrangement 18. With such a configuration, the bottom of the second arrangement 18 flatly bears against the high tonnage winch grillage 22 to advantageously limit bending of the sacrificial elongate plates 86 during loading.

In FIG. 3, each lower edge 88 of the sacrificial elongate mounting plates 86 is welded to a parallel I-beam of the high tonnage winch grillage 22. The sacrificial elongate plates 86 are advantageously welded in line with the central flange of the I-Beam for strength.

This manner of attachment shown in FIG. 3 is considered to be particularly advantageous for the reason that a flush, safe, narrow configuration, low profile, and reusable manner of attachment are provided together with an improved winch base 56. As shown in FIG. 3 four sacrificial elongate mounting plates 86 are located on opposite parallel sides of the second arrangement 18 adjacent each corner.

Furthermore, the advantageous use of the second arrangement 18 to protect the sacrificial mounts 78 does not make removal of the winch base 56 and the sacrificial mounts 78 difficult. With the holes 72 being threaded and extending into the vertical side walls 74 of the second arrangement 18, the fasteners 82 can be unthreaded to release the sacrificial elongate plates 86 from the second arrangement 18. The winch base 56 is then removed by lifting the first arrangement 16, the second arrangement 18 and the slew ring bearing 28 as one self contained unit. Once the winch base 56 has been removed, this allows a gas cutting torch to advantageously cut through the sacrificial plates 86 to remove the sacrificial plates 86 from the high tonnage winch grillage 22. If the winch base 56 was not removed from its position, air arc gouging equipment would have to be used to cut the sacrificial plates 86 as opposed to a gas cutting torch. Otherwise the second arrangement would be damaged by say an oxy torch given its high powered gas cutting flame. In addition some damage to the bottom plate would be unavoidable even with the use of air arc gouging equipment. With the present system the winch base 56 is not damaged at all. Furthermore, oxy torches are commonly available on offshore vessels and platforms where gauging torches are not.

As shown in FIG. 4, the holes 72 are grouped into three groups on each vertical side 74 of the second arrangement 18. The provision of holes 72 adjacent to the corner portions and middle portions of the second arrangement 18 is considered to be advantageous as it allows for different groups of the holes 72 to accommodate high tonnage winch grillage of different configurations.

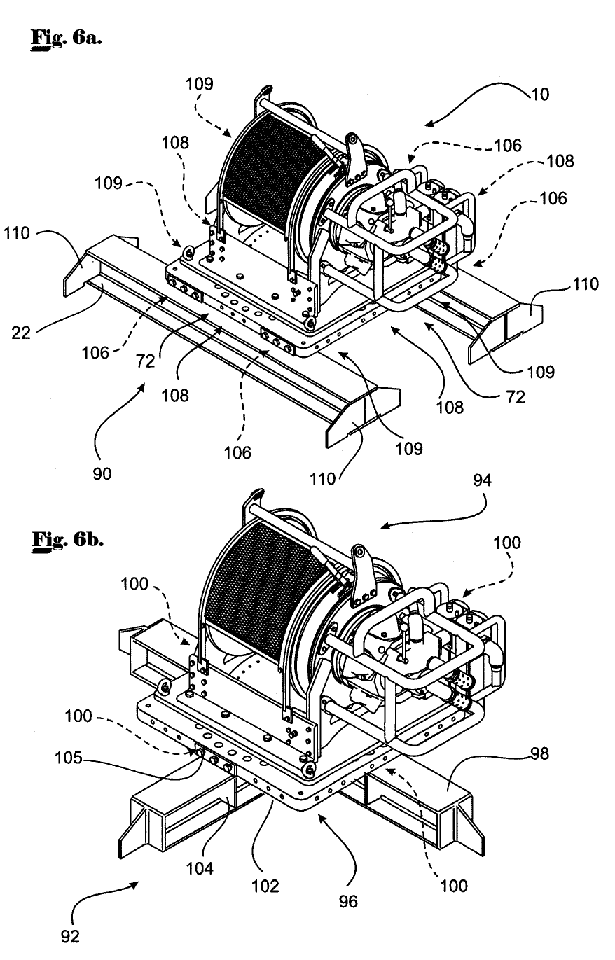

FIG. 6 provides a perspective view 90 of the winch system 10 and a perspective view 92 of a further winch system 94 according to another preferred embodiment. The winch system 94 includes a winch base 96 that is identical to the winch base 56. In distinction from winch system 10, the winch system 94 further includes high tonnage winch grillage 98 of a cruciform configuration comprising two crossing I-beams directly beneath the winch base 96.

As shown, the winch base 96 includes a number of centrally located holes 100 extending into side walls 102. Also apparent is a further support 104 in the form of welded plate portion added to the I-Beams of the grillage 98 directly below a sacrificial elongate plates 105 used to mount the winch base 96. In this case two supports 104 advantageously provide support at each location beneath each of the four sacrificial plates 105 when mounted to the grillage 98. The ability of identical winch bases to be securely mounted above both parallel and cruciform grillage in the form of structural support elements is considered to be particularly advantageous

In the case of the winch system 10, it will now be apparent that holes 106 on the corner portions of the second arrangement 18 allow for the winch base 56 to be mounted to parallel high tonnage winch grillage. The provision of the holes 108 on the central portion of the second arrangement 18 allow for the winch base 56 to be mounted to cruciform high tonnage winch grillage. Further holes 109 allow for attachment to further parallel configurations similarly to the holes 106. The ability to reuse the winch base 56 on both parallel and cruciform high tonnage winch grillage, as shown, is considered to be advantageous. As would be apparent, the winch base 56 provides an advantageous winch system in its own right and can be sold as an off the shelf unit. The high tonnage winch grillage 22 can be lengthened or shortened to the required specification.

The holes 72 in the second arrangement 18 are grouped in series of three holes extending along the length of the sides 74. Each grouping advantageously spans the width of an I-beam as shown in the case of winch system 94. This serves to advantageously provide a secure connection to the grillage. With the holes being arranged in a single series, this also advantageously accommodates the low profile of the second arrangement 18. Having three or more groups of holes 72 on each of the sides 74 is considered to be advantageous. As shown a flush, secure, narrowly configured, reusable, low profile manner of attachment is advantageously provided.

The sacrificial elongate plates 86 in the embodiment are a consumable item. They are welded to the high tonnage grillage 22 to secure the winch base 56. In other embodiments the sacrificial elongate plates 86 may be welded directly to the structure upon which the winch is to be mounted. That is, in other embodiments, there may be no high tonnage winch grillage.

In this arrangement the sacrificial elongate plates comprise 20 by 10 cm plates with three 20 mm holes to accept three M20 class 8.8 bolts. As would be apparent, the quantity, size and grade of the bolts must support the forces carried by the winch system 10. It can be generally expected that the larger the working load limit the larger the quantity and number of bolts and the larger the sacrificial elongate plates. In the winch system 10 there are a minimum of four sacrificial plates symmetrically located around the perimeter of the second arrangement 18. Furthermore, various forms and combinations of cruciform and parallel grillage can also clearly be advantageously accommodated with the use of more sacrificial plates.

As would be apparent there is advantageously no need to weld the sacrificial elongate plates 86 to the second arrangement 18. After use the second arrangement 18 remains as it was built and consequently retains its usability. As the sacrificial plates 86 can be bolted in three separate locations on each of the four side faces of the second arrangement 18, this provides a large degree of flexibility. To remove the winch base 56 it is a relatively quick and simple task of removing 12 bolts (3 bolts per 4 tabs). Each of these advantages provides a very flexible winch system for offshore construction, transport and docking operations. The use of the sacrificial elongate plates 86 is also considered to advantageously allow for cost effective fabrication.

In the winch system 10, the high tonnage winch grillage 22 includes a number of dog plates 110 for being welded to the hard points 34 on the deck 20. The size and configuration of the grillage 22 and the dog plates 110 can be readily varied for a particular hard point configuration. This is considered to be advantageous as the combinations/configurations can be varied to satisfy a client's individual requirements, as driven by the layout and type of structure of the particular deck.

With grillage being a consumable simply made up of straight beams of various form with minimal to no fabrication, the grillage can remain attached to the deck 20 even when the winch base 56 has been removed. This keeps operational flexibility high and can serve to reduce costs. Furthermore with modular pre-engineered grillages it is considered possible that a high percentage of all winch base requirements can be fulfilled without the need to engage an experienced engineer, saving the client time and money. In preferred embodiments winch grillage can be designed for a number of standard vessel and platform hard point spacings.

The profile of the winch base 56 is in effect limited by the thickness of the first arrangement 12, the second arrangement 18 and the slew ring bearing 28. In this respect, it is to be appreciated that the thickness of the first arrangement could range from 20 to 50 mm depending on the working load limit of the winch system 10. For example a 5 tonne winch will require a thinner top plate than one designed for a 10 tonne winch.

As discussed the second arrangement 18 will generally be significantly thicker than the first arrangement 12. This occurs for a number of reasons. Firstly the second arrangement 18 must support the provision of the locking holes 54 which must transfer all of the rotational forces exerted by the locking pin 48 on the perimeter of the bolt hole. Secondly, the provision of the holes 72 in the side walls 74 together with the sacrificial elongate plates 86 may dictate a minimum thickness. It is conceivable that the thickness of the second arrangement 18 could range from 40 to 100 mm. In terms of the horizontal sizing, the retractable locking pin mechanism 38 is advantageously be positioned on a small platform 112 extending outside the general rectangular shape of the first arrangement 12.

In summary, it will accordingly be appreciated that there has been described a high tonnage winch system 10 for use in offshore construction, transport and docking operations. The winch system 10 includes a winch 14 and a first arrangement 12 supporting the winch 14. A second arrangement 18 is provided for being mounted to a foundation structure in the form of a deck 20. The first arrangement 12 advantageously comprises a first low profile arrangement 16. The second arrangement 18 advantageously comprises a second low profile arrangement 24. The winch system 10 includes a low profile roller element bearing 26 connecting the first and second arrangements 12, 18 and allowing rotation of the winch 14 about the second arrangement 12, when the winch 14 is connected to the first arrangement 12 and the second arrangement 18 is mounted to the deck 20. In this embodiment the second arrangement is mounted to the deck 20 using high tonnage winch grillage 22.

The winch system includes several advantageous features including a locking arrangement 38 and a mount arrangement 76. The locking arrangement 38 locks the winch 14 in position for high tonnage offshore construction, transport or docking operations. The mount arrangement 76 advantageously mounts the winch 14 to the deck 20 using the high tonnage winch grillage 22. The high tonnage winch grillage 22 can be selected from the group comprising high tonnage grillage of a cruciform configuration and high tonnage grillage of a parallel configuration. The ability to select cruciform or parallel grillage is considered to be particularly advantageous.

Further, the winch system 10 generally provides a highly configurable winch base solution that can be provided ‘off the shelf’ with some possibly some modification. The winch orientation can be readily selected so as to be independent of grillage orientation where the winch can be rotated 360 degrees. The winch can be positioned in any of the 36 pre-defined positions using 10 degree rotation increments. It is considered that such an advantageous system can replace several winches mounted on conventional fixed bases with relatively less engineering design where the winch base is advantageously re-usable. Each winch base is able to accommodate a number of different winch models.

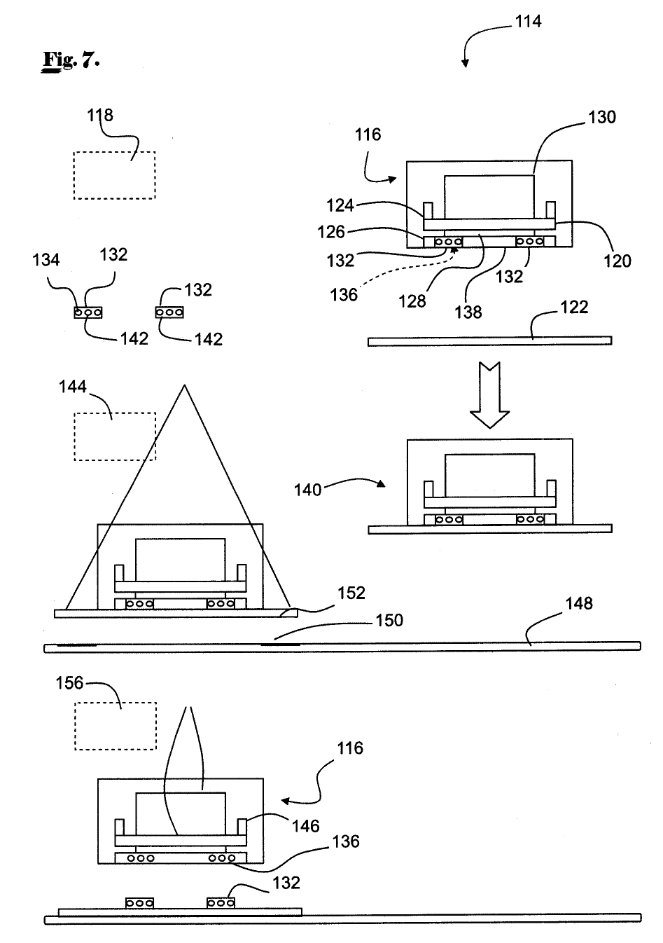

Referring to FIG. 7 there is shown a method 114, according to a further preferred embodiment of the present invention. The method 114 provides for the advantageous installation of a winch system 116 for performing offshore construction, transport and docking operations.

At block 118, the method 114 includes attaching a high tonnage winch base 120 to high tonnage winch grillage 122. The high tonnage winch base 120 comprises a first low profile arrangement 124 that is connected to a second low profile arrangement 126 by a low profile roller element bearing 128. The low profile roller element bearing 128 allows rotation of a winch 130 about the second low profile arrangement 126.

At block 118, attaching the high tonnage winch base 120 includes attaching the second low profile arrangement 126 to the high tonnage winch grillage by fastening a number of sacrificial elongate plates 132 having a single series of holes 134 corresponding with mounting elements 136 provided on the side walls 138 of the second low profile arrangement 126. The method 114 includes cutting and welding a lower edge 142 of each length of the sacrificial elongate plates 132 to the high tonnage winch grillage 122 to provide a winch system 140.

At block 144, after welding the lower edge 142 of each of the sacrificial elongate plates 132, the winch base 120 is lifted using from the grillage 122 as is known. The winch base 120 is then relocated to a position above a foundation 148. The foundation 148 has a number of hard points 150 onto which the high tonnage winch grillage 122 is subsequently placed.

The high tonnage winch grillage 122 includes a number of dog plates 152 cut in an “L”-type shape from plate material. At block 144, the dog plates 152 are welded to the hard points 150. The steelwork forming the high tonnage winch grillage 122 advantageously distributes offshore construction, transport and docking loads and secures the winch system 116 to the deck for both transit and operation.

Referring to FIG. 7, the method 114 advantageously further includes reusing the winch base 120. At block 156 of the method 114, the winch base 120 is removed from the high tonnage winch grillage 122 by firstly unfastening fasteners extending through the sacrificial elongate plates 132 serving to hold the winch base 120 in position. Following this an oxy welder is advantageously used to cut through the sacrificial plates 132 by making use of the space provided by the removal of the winch base 120. Any left over material is ground away from the high tonnage winch grillage 122 that can be reused for another operation or removed, if desired.

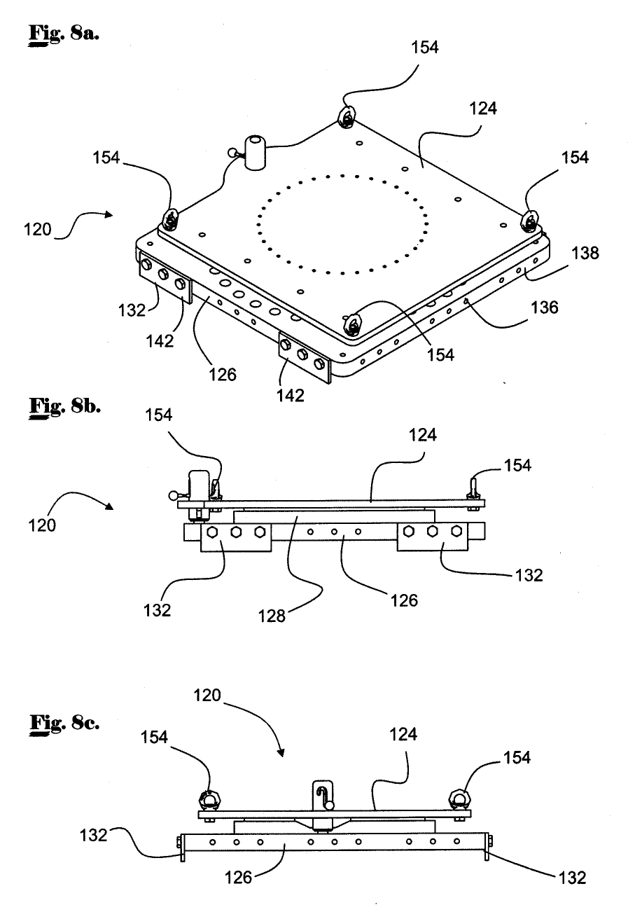

It preferred to lift the winch base 120 and the winch 130 off together by wrapping a sling around the drum of the winch 130 or by using the winch's lift bar. If however the winch 130 is removed before the winch base 120, the system advantageously includes a number of lifting supports 146 at each corner of the first low profile arrangement 124. As highlighted in FIG. 8, the lifting supports 146 comprise 4 off lift eye bolts 154. These eye bolts 154 allow for the winch base 120 to be lifted by the top plate using a 4-leg sling. The four off lift eye-bolts 154 also allow for the top plate 124 to be easily handled during assembly of the winch base 120. The rectangular shape is considered to be useful for lifting as well as accommodating the rectangular foot print of particular winches. Other shapes could of course also be used. FIG. 8 clearly illustrates the advantageous low profile of the winch base 120.

In the embodiment, the working load limit of the winch system 116 advantageously ensures a high tonnage capacity for offshore construction, transport and docking operations. The winch 120 is a high power driven winch for extending wire cable from several to 100 meters or more. The system is designed to withstand at a minimum the working load limit of the winch 130. The winch base 120 is able to withstand wire break loads generally 5 times the working load limit.

The roller element bearing 128 consists of many rows of balls or other roller elements designed to support high radial, axial and moment loads associated with such operations. In this embodiment a slew ring bearing provides particular advantages including the smooth continuous movement of the winch with a relatively minimal amount of friction. Different forms of rolling-element bearing may be used in different applications.

It is to be appreciated that the winch system 116 advantageously provides a standard of the shelf base unit that can be reused and accommodate a very large number of offshore winch mounting scenarios whilst providing substantial operational flexibility not presently available with current systems and methods.

The method 114 allows for ready installation and removal of the winch 130 and winch base 120. The winch base 120 advantageously supports the weight of the high tonnage winch 130 including the winch wire. The winch base 120 supports the winch during installation and removal. During operation, the winch base 120 is advantageously able to accommodate high tonnage bending and other loads associated with offshore construction, transport and docking.

The winch system 116 safely transmits all forces to locations on the mounting structure of the deck. Importantly the winch base 120 can be readily orientated to a direction of its intended use to accommodate a number of offshore construction, transport and docking operations. With the use of winch system 116, no longer must particular winch bases be designed for offshore construction, docking and transport operations where the winch bases comprise custom pieces of equipment designed and fabricated to suit only a single application. This is particularly the case with asymmetric systems.

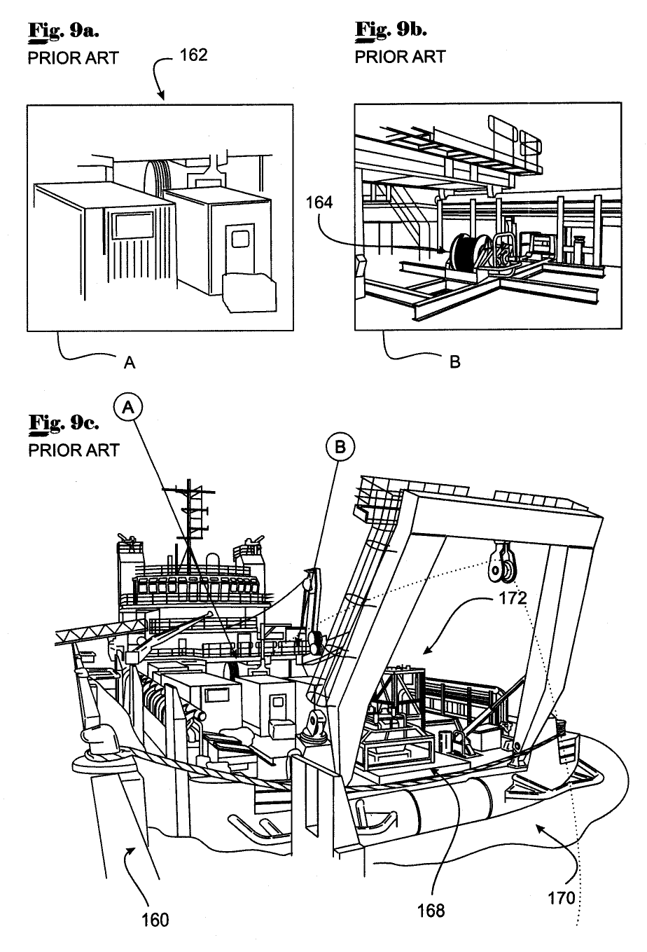

Referring to FIG. 9 there is shown a vessel 160. The vessel 160 includes a first winch 162 and a second winch 164, The first winch 162 and the second winch 164 are to be used to overboard (lower down) equipment from a deck 168, of the vessel 160 over both over an aft end 170 and over a starboard side 172. Both these winches have their own bespoke designed winch bases arranged such that the first winch 162 points aft and the second winch 164 points starboard.

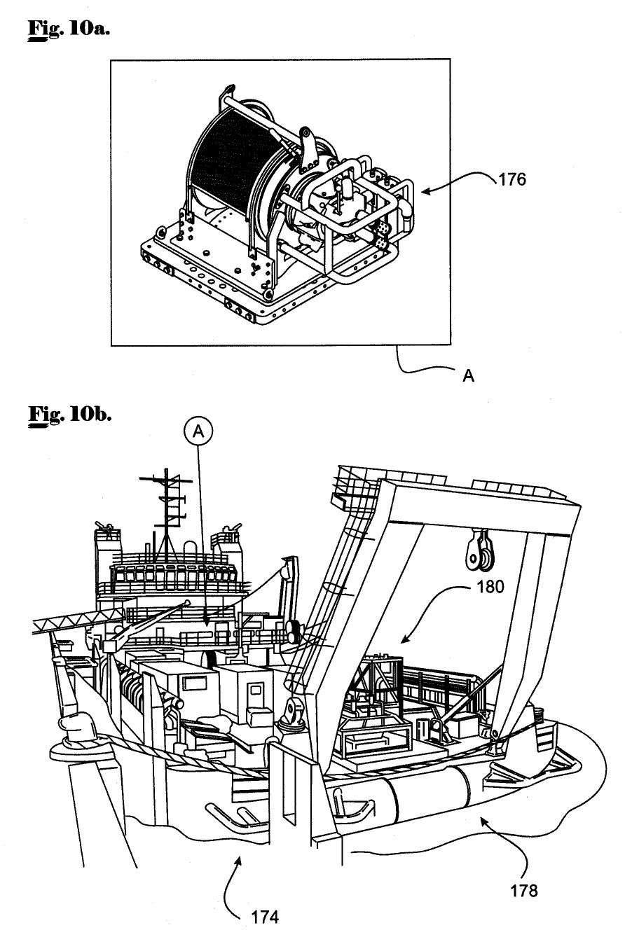

FIG. 10 illustrates a vessel 174 where a second winch is not required due to provision of a winch system 176 according to an embodiment of the present invention. The winch system 176 is able to lower equipment over both over an aft end 178 and over a starboard side 180. There are numerous applications where preferred embodiments avoid the need for multiple winches in offshore construction, transport and docking operations.

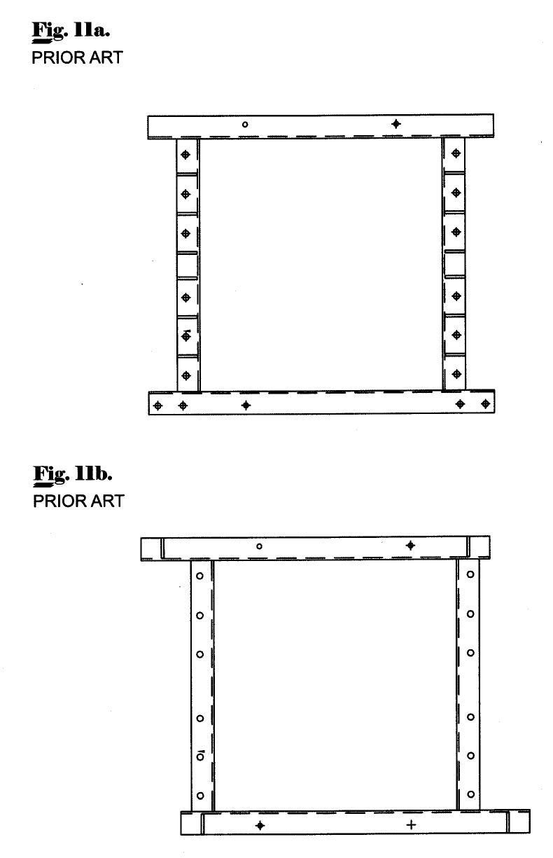

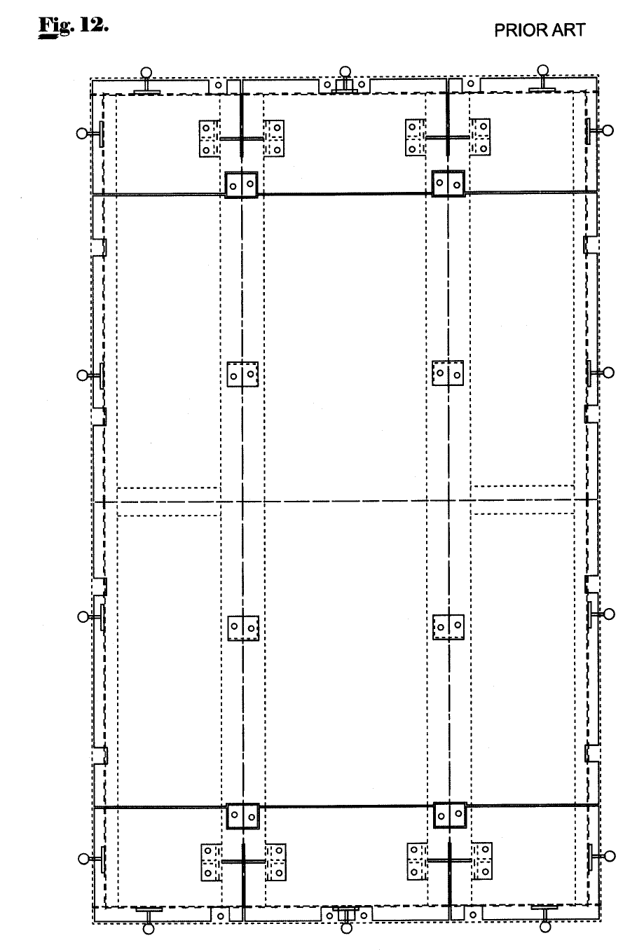

Methods and systems of the present invention, in embodiments are considered to advantageously obviate the need for custom winch bases and multiple winches in a side by side configuration where additional restrictions exist or are imposed on winch base designers when there is a need to mount a winch to the deck of a vessel or similar plate structure. Similarly, it is considered to be simpler with embodiments of the present invention to accommodate decks having insufficient structural capacity to resist the operational loads generated by the winch and where particular grillage and winch orientations are required. By transferring loads from the winch base back to structural elements with sufficient capacity, different operations can be accommodated. Furthermore different hard point spacings can be accommodated with different configurations of grillage to provide a foundation with sufficient capacity to carry loads that do not coincide with the position or required orientation of the winch when mounted to a conventional base. The need for both multiple winches and specially designed asymmetric winch bases is considered to be addressed in an advantageous manner. FIGS. 11 and 12 illustrate the engineering complexity associated with the prior art system of FIG. 2 where an asymmetric winch base is involved.

As discussed above, the preferred embodiments provide a number of advantages including:
(i) The ability to re-orientate a high tonnage winch on a oil and gas service vessel or platform, where the high tonnage winch can be locked in 36 operational positions for performing a relatively large number of offshore construction, transport and docking operations.
(ii) Improved high tonnage winch systems that can be sold as a commercial off the shelf product having wide ranging usability for offshore construction, transport and docking operations as opposed to a specifically engineered high tonnage winch system having components primarily suited to only one hard point layout.
(iii) Improved high tonnage winch base systems for offshore construction, transport and docking operations where the advantageous use of a slew ring bearing between two specifically engineered winch base plates provides a relatively low profile rotatable winch base that smoothly supports a high tonnage winch and allows for a relatively large number of offshore construction, transport and docking operations on an oil and gas vessel or platform.
(iv) The ability to readily reuse a high tonnage winch base in a number of applications after the winch base has been fixed in position on high tonnage winch grillage for offshore construction, transport and docking operations.
(v) The ability to fix a high tonnage winch base to a variety of different high tonnage winch grillage layouts where the winch base can be readily installed and removed by bolting a number of sacrificial mounts along low profile side walls of a lower winch base plate.
(vi) The ability to readily mount a high tonnage winch base for offshore construction, transport and docking operations to both cruciform and parallel high tonnage winch grillage layouts, without having to engineer the mounting arrangement to the same degree as is presently the case with conventional angularly offset high tonnage winch bases for offshore applications.

It is to be appreciated that the present invention may also find application in onshore applications such as on building sites and on trucks, possibly using different forms of hoist type winches. Whilst the present invention is adapted for use in offshore construction, transport and docking operations, the present invention is not limited to these applications. The applicant is presently investigating use of the advantageous winch base with trucks and general onshore construction.

As would be apparent, various alterations and equivalent forms may be provided without departing from the spirit and scope of the present invention. This includes modifications within the scope of the appended claims along with all modifications, alternative constructions and equivalents.

In the present specification, the presence of particular features does not preclude the existence of further features. The words ‘comprising’, ‘including’ and ‘having’ are to be construed in an inclusive rather than an exclusive sense.

The claims defining the invention are as follows:

1. A high tonnage winch system for use in offshore construction, transport and docking operations comprising: a first arrangement for supporting a winch in a position proximate the first arrangement; and a second arrangement for being mounted to a foundation structure; wherein the first arrangement comprises a first low profile arrangement, the second arrangement comprises a second low profile arrangement, the high tonnage winch system including a low profile roller element bearing connecting the first and second low profile arrangements and allowing rotation of the winch about the second low profile arrangement, when the winch is connected to the first low profile arrangement and the second low profile arrangement is mounted to the foundation structure.

2. A high tonnage winch system as claimed in claim 1 further comprising a locking arrangement for locking the winch in a plurality of operational positions by locking the first low profile arrangement and the second low profile arrangement in a plurality predetermined rotational conditions where the rotational conditions are associated with spaced apart intervals of no more than 45 degrees so as to allow the winch to be locked in at least 8 operational positions for offshore construction, transport or docking operations.

3. A high tonnage winch system as claimed in claim 1 wherein the low profile roller element bearing comprises a slew ring bearing that provides relatively smooth rotation of the first low profile arrangement relative to the second low profile arrangement and which is adapted to accommodate high tonnage loads from the winch.

4. A high tonnage winch system as claimed in claim 1 wherein the first arrangement comprises a low profile planar element having side walls no more than 35 mm high.

5. A high tonnage winch system as claimed in claim 1 wherein the second arrangement comprises a low profile planar element having side walls no more than 100 mm high.

6. A high tonnage winch system as claimed in claim 1 wherein the first arrangement comprises a low profile planar element having side walls no more than 35 mm high and the second arrangement comprises a low profile planar element having side walls no more than 100 mm high.

7. A high tonnage winch system as claimed in claim 1 wherein each of the first low profile arrangement, the second low profile arrangement and the roller element bearing provide a winch base with a profile no more than 200 mm high.

8. A high tonnage winch system as claimed in claim 1 wherein the first arrangement includes lifting elements for allowing the high tonnage winch system to be readily raised and lowered during installation.

9. A high tonnage winch system as claimed in claim 1 wherein the first arrangement is provided as a single planar rectangular piece of material with the lifting members being located at each corner of the first arrangement.

10. A high tonnage winch system for use in offshore construction, transport and docking operations comprising: a winch base including a first arrangement for supporting a winch and a second arrangement for being mounted to a foundation structure; wherein the winch base includes: a roller element bearing for connecting the first and second arrangements and allowing rotation of the winch about the second arrangement, when the winch is connected to the first arrangement and the second arrangement is mounted to the foundation structure; further wherein the winch base includes a mount arrangement including a plurality of mount elements spaced apart for use in mounting the second arrangement to the foundation structure using high tonnage winch grillage of different configurations.

11. A high tonnage winch system as claimed in claim 10 including a plurality of sacrificial elongate mounts having fastening holes for being fastened to the second arrangement using the mount elements such that the length of each sacrificial elongate mount extends along the sides of the second arrangement and presents a lower edge for being welded to the high tonnage winch grillage; wherein unfastening the sacrificial elongate plates from the mount elements allows ready separation of the winch base from the high tonnage winch grillage.

12. A high tonnage which system as claimed in claim 10 wherein the mount elements comprise threaded holes formed so as to extend into the vertical side walls of the second arrangement when mounted to the foundation structure using the high tonnage winch grillage, the threaded holes being adapted to receive fastening bolts for holding the sacrificial elongate members to the second arrangement.

13. A high tonnage winch system as claimed in claim 10 wherein the mount elements are spaced along the vertical side walls of the second arrangement so as to allow the second arrangement to be mounted to both high tonnage winch grillage of a cruciform configuration and high tonnage winch grillage of a parallel configuration.

14. A high tonnage winch system as claimed in claim 10 wherein the mount elements are grouped into groups of mount elements along the vertical side walls of the second arrangement so as to provide different groups of the mount elements for accommodating both high tonnage winch grillage of a cruciform configuration and high tonnage winch grillage of a parallel configuration.

15. A high tonnage winch system as claimed in claim 10 wherein the second arrangement is provided as a single planar rectangular piece of material with the mount elements being grouped into three groups on each vertical side of the second arrangement.

16. A high tonnage winch system as claimed in claim 15 wherein each mount element is spaced along the side walls of the second arrangement.

17. A high tonnage winch system as claimed in claim 10 wherein the second arrangement comprises a low profile plate having side walls no more than 35 mm high.

18. A high tonnage winch system as claimed in claim 10 wherein the first arrangement comprises a low profile plate having side walls no more than 100 mm high.

19. A high tonnage winch system as claimed in claim 10 wherein the second arrangement comprises a low profile plate having side walls no more than 35 mm high and the first arrangement comprises a low profile plate having side walls no more than 100 mm high.

20. A high tonnage winch as claimed in claim 10 wherein each of the first arrangement, the second arrangement and the roller element bearing provide the winch base with a profile no more than 150 mm high.

21. A high tonnage winch system for use in offshore construction, transport and docking operations comprising: a winch; a first arrangement supporting the winch; and a second arrangement for being mounted to a foundation structure; wherein the first arrangement comprises a first low profile arrangement, the second arrangement comprises a second low profile arrangement, the system including: a low profile roller element bearing connecting the first and second arrangements and allowing rotation of the winch about the second arrangement, when the winch is connected to the first arrangement and the second arrangement is mounted to the foundation structure; and a locking arrangement for locking the winch in position by locking the first arrangement and the second arrangement in any one of a plurality predetermined rotational conditions where the rotational conditions are associated with spaced intervals of no more than 45 degrees allowing the winch to be locked in any one of at least 8 operational positions for offshore construction, transport or docking operations.

22. A high tonnage winch system as claimed in claim 21 including a mounting arrangement for mounting the second arrangement to the foundation structure, the mounting arrangement including high tonnage winch grillage selected from the group comprising high tonnage grillage of a cruciform configuration and high tonnage grillage of a parallel configuration.

23. A method of installing a winch system for performing offshore construction, transport or docking operations including: attaching a high tonnage winch base to high tonnage winch grillage, the winch base comprising a first low profile arrangement that is connected to a second low profile arrangement by a low profile roller element bearing, the low profile roller element bearing allowing rotation of a winch about the second low profile arrangement; attaching the high tonnage winch base including attaching the second low profile arrangement to the high tonnage winch grillage by fastening sacrificial elongate plates having a single series of holes corresponding with mounting elements provided on the side walls of the second low profile arrangement, and welding a lower edge of each length of the sacrificial elongate plates to the high tonnage winch grillage.

24. A method of reusing a winch system for performing offshore construction, transport or docking operations including: removing the winch base from high tonnage winch grillage attached to a foundation by firstly unfastening fasteners extending through sacrificial plates serving to hold the winch base in position, where the winch base comprises a first low profile arrangement that is connected to a second low profile arrangement by a low profile roller element bearing, the low profile roller element bearing allowing rotation of the winch about the second low profile arrangement and the sacrificial plates being attached to the second low profile arrangement; and by making use of the space provided by the removal of the winch base, removing the sacrificial mounting plates using a gas cutting torch.
